(19) United States
(12) Patent Application Publication
(10) Pub. No.: US 2025/0388404 A1
(43) Pub. Date: Dec. 25, 2025

(54) Article Shipment System

(71) Applicant: Daifuku Co., Ltd., Osaka-shi (JP)

(72) Inventor: Yuya Yoshikawa, Tokyo (JP)

(21) Appl. No.: 19/242,093

(22) Filed: Jun. 18, 2025

(30) Foreign Application Priority Data
Jun. 19, 2024 (JP) 2024-098859

(51) Int. Cl. B65G 1/137; B65G 1/12; B65G 61/00

(52) U.S. Cl. CPC B65G 1/1378; B65G 1/12; B65G 61/00

(57) ABSTRACT

An article shipment system includes a warehouse that stores a support, an unloading device that unloads an article from the support, and a loading device that loads an article onto the support. In response to a specified number being greater than or equal to a set number and less than a first loading number, the article shipment system unloads a remaining number of articles from a first support with the unloading device while leaving a flat-upper-surface number of articles on the first support, loads, with the loading device, a first remaining loading number of articles among the remaining number of articles onto a shipping support, and ships the first support and the shipping support. The remaining number is obtained by subtracting the flat-upper-surface number from the first loading number.

### CROSS-REFERENCE TO RELATED APPLICATION

This application claims priority to Japanese Patent Application No. 2024-098859 filed Jun. 19, 2024, the disclosure of which is hereby incorporated by reference in its entirety.

### BACKGROUND OF THE INVENTION

### Field of the Invention

The present invention relates to an article shipment system for shipping articles loaded on a support.

### Description of Related Art

An example technique for loading articles onto a support is described in Japanese Unexamined Patent Application Publication No. 2022-11857 (JP 2022-11857). In the background described hereafter, reference signs in parentheses are the reference signs in JP 2022-11857. With the technique described in JP 2022-11857, articles (22) transferred from an automated warehouse (200) are loaded onto a pallet (21) one by one to form an article group (20) including the pallet (21) and the articles (22) loaded on the pallet (21). The articles (22) at the upper end of the article group (20) when loaded on the pallet (21) serve as mounts (multiple posts (20p) shown in FIG. 4 in JP 2022-11857), on which another pallet (21) can be placed substantially horizontally and stably. Multiple article groups (20) are stacked on one another to form a transport unit (10) shown in FIG. 1 in JP 2022-11857.

As described above, JP 2022-11857 describes a technique for loading articles transferred from a warehouse onto a support (a pallet in JP 2022-11857) one by one to prepare a support loaded with multiple articles on which another support can be stacked easily. Articles, being loaded on a support, may be stored in an automated warehouse. In such a case, the support may be loaded with multiple shipping target articles to facilitate stacking of another support. In this case, the warehouse transfers not articles but the support loaded with articles, unlike in JP 2022-11857. JP 2022-11857 contains no reference to the manner of preparing a support loaded with multiple articles to facilitate stacking of another support.

### SUMMARY OF THE INVENTION

For articles loaded on a support to be stored in a warehouse, an article shipment system is awaited for appropriately loading articles onto a support to facilitate stacking of another support.

An article shipment system according to an aspect of the disclosure is a system for shipping a specified number of articles loaded on a support. The specified number is specified by order information. The support is loadable with a plurality of article layers vertically stacked on one another. Each of the plurality of article layers includes a set number of articles arranged in a planar manner. The article shipment system includes a warehouse that stores the support loaded with one or more articles, an unloading device that unloads an article among the one or more articles from the support, and a loading device that loads an article onto the support. The warehouse stores a first support loaded with a first loading number of articles and a second support loaded with a second loading number of articles. The second loading number is greater than or equal to the first loading number. The article shipment system, in response to the specified number being greater than or equal to the set number and less than the first loading number, unloads a remaining number of articles from the first support with the unloading device while leaving a flat-upper-surface number of articles on the first support, loads, with the loading device, a first remaining loading number of articles among the remaining number of articles onto a shipping support other than the first support and the second support, and ships the first support and the shipping support. The flat-upper-surface number is defined based on an integer multiple of the set number within a range to allow an uppermost article layer on the first support to have a substantially flat upper surface and is less than or equal to the first loading number and less than or equal to the specified number. The first remaining loading number is obtained by subtracting the flat-upper-surface number from the specified number. The remaining number is obtained by subtracting the flat-upper-surface number from the first loading number. The article shipment system, in response to the specified number being greater than the first loading number, unloads the remaining number of articles from the first support with the unloading device while leaving the flat-upper-surface number of articles on the first support, unloads a first shortage number of articles from the second support with the unloading device, loads the remaining number of articles and the first shortage number of articles onto the shipping support with the loading device, and ships the first support and the shipping support. The first shortage number is obtained by subtracting the remaining number from the first remaining loading number.

When the warehouse for storing supports loaded with article stores the first support and the second support, the structure can prepare the first support loaded with the flat-upper-surface number of articles and ship the specified number of articles with the first support and the shipping support, independently of whether the specified number specified by order information is less than or greater than the first loading number that is the number of articles loaded on the first support. The flat-upper-surface number is a number within the range that allows the uppermost article layer on the support to have a substantially flat upper surface. The prepared first support can thus be loaded with multiple articles to facilitate stacking of another support. When transporting the shipped support including the first support, another support including the shipping support can be easily stacked on the multiple articles loaded on the first support. This facilitates efficient transportation of the shipped articles.

As described above, for articles being loaded on a support to be stored in a warehouse, the structure can appropriately prepare a support (specifically, the first support) loaded with multiple articles to facilitate stacking of another support.

Further features and advantages of the article shipment system will become apparent from the following description of the embodiments described with reference to the drawings.

### BRIEF DESCRIPTION OF THE DRAWINGS

FIG. 1 is a schematic diagram of an article shipment system according to an embodiment.

FIG. 2 is a diagram of a shipment process in a first example.

FIG. 3 is a diagram of a shipment process in a second example.

FIG. 4 is a diagram of a shipment process in a third example.

FIG. 5 is a diagram of a shipment process in a fourth example.

FIG. 6 is a diagram of a shipment process in a fifth example.

FIG. 7 is a diagram of a shipment process in a sixth example.

FIG. 8 is a diagram of a shipment process in a seventh example.

FIG. 9 is a diagram of a shipment process in an eighth example.

### DESCRIPTION OF THE INVENTION

An article shipment system according to one or more embodiments will now be described with reference to the drawings. The article shipment system ships a specified number of articles loaded on a support. The specified number is specified by order information. The technical features of the article shipment system described herein are also applicable to an article shipping method for shipping a specified number of articles loaded on a support or an article shipping program for causing a computer to function as an article shipment system (specifically, a control system described later). The article shipment system, the article shipping method, and the article shipping program, as well as a storage medium (e.g., a computer-readable recording medium such as an optical disc or a flash memory) storing the article shipping program are also described herein.

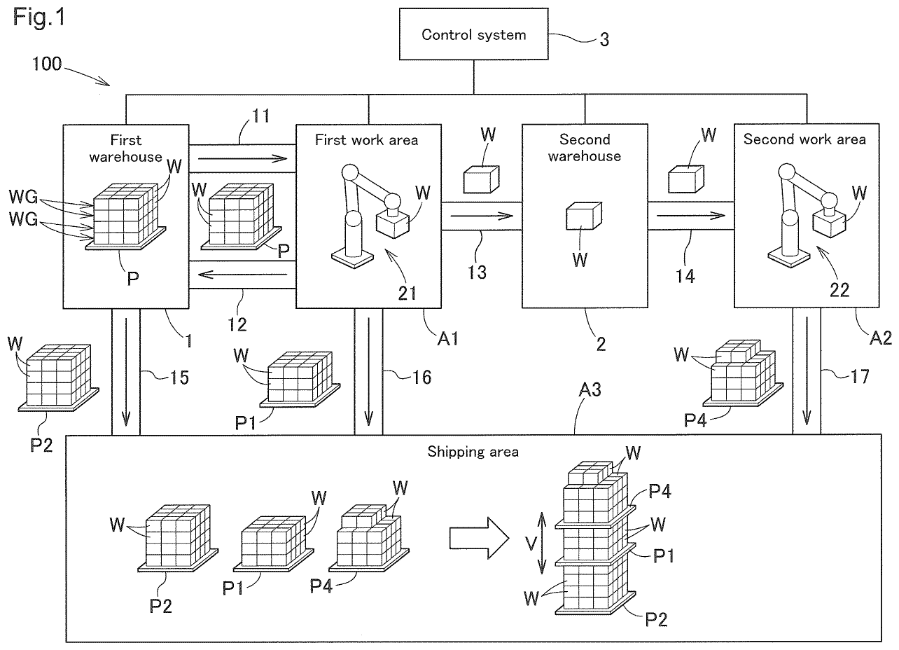

As shown in FIG. 1, an article shipment system 100 includes a warehouse (a first warehouse 1 in the present embodiment) storing a support P loaded with one or more articles W, an unloading device (a first work device 21 in the present embodiment) for unloading articles W from the support P, and a loading device (the first work device 21 and a second work device 22 in the present embodiment) for loading articles W onto the support P. The first work device 21 and the second work device 22 may be, for example, robots such as articulated robots. In the present embodiment, the first warehouse 1 corresponds to a warehouse. The first work device 21 corresponds to an unloading device and a loading device (specifically, a loading device that loads articles onto a first support or a storage support). The second work device 22 corresponds to a loading device (specifically, a loading device that loads articles onto a shipping support).

In the present embodiment, the article shipment system 100 further includes a second warehouse 2 storing an article W, a first work area A1, a second work area A2, and a shipping area A3. The first work area A1 includes the first work device 21. In the first work area A1, the first work device 21 unloads articles W from the support P and loads articles W onto the support P. The first work device 21 as the unloading device that unloads articles W from the support P may be a separate device from the first work device 21 as the loading device that loads articles W onto the support P. The second work area A2 includes the second work device 22. The second work device 22 loads articles W onto the support P in the second work area A2.

In the shipping area A3, articles Ware shipped to a shipping destination (e.g., a store or another distribution center). The shipping area A3 is, for example, adjacent to a truck berth. In the present embodiment, shipping of articles W performed by the article shipment system 100 refers to shipping of articles W (shipping target articles W) to the shipping area A3. More specifically, the shipping destination of articles W for the article shipment system 100 is the shipping area A3. The article shipment system 100 transports articles W into the shipping area A3. Articles W, being loaded on the support P, are transported into the shipping area A3.

After being transported into the shipping area A3, the articles W loaded on the supports P are shipped from the shipping area A3. In the present embodiment, articles W are shipped from the shipping area A3 in a stack of multiple supports P sandwiching the articles W. In the shipping area A3 in FIG. 1, a first support P1 loaded with articles W and a shipping support P4 loaded with articles W are stacked in this order on a second support P2 loaded with articles W. The first support P1, the second support P2, and the shipping support P4 will be described later. The stack is loaded onto, for example, a truck, a railway vehicle, a ship, or an airplane, for shipment from the shipping area A3 to a destination. The shipping area A3 includes, for example, a stacking device that stacks supports P each loaded with articles W. At least part of the work for shipping the articles W in the shipping area A3 (e.g., the work of preparing the stack or the work of loading the stack onto, for example, a truck) may be performed by the article shipment system 100.

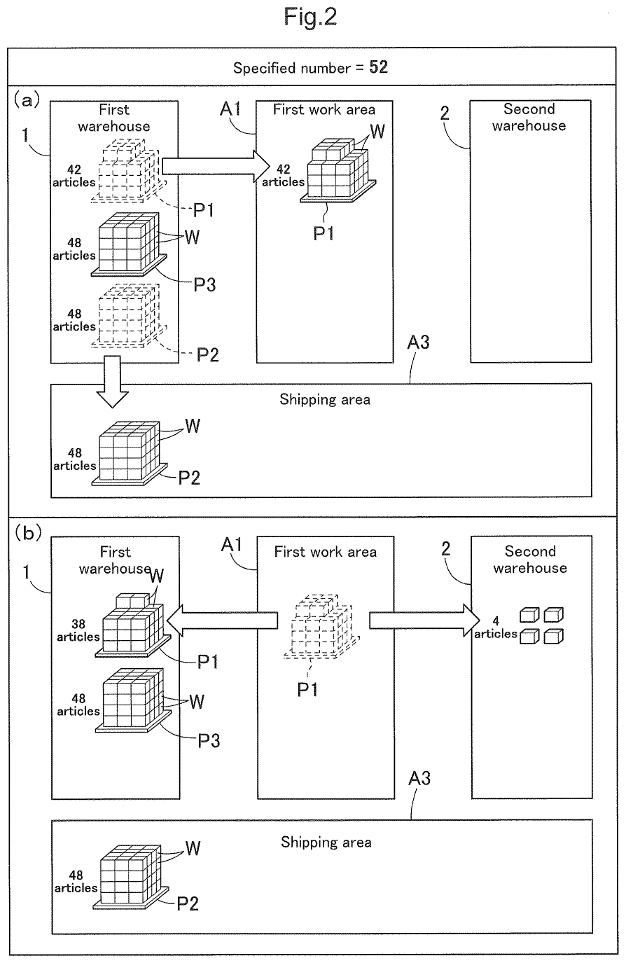

Each support P can receive multiple article layers WG stacked in a vertical direction V (in the direction of gravity). Each article layer WG includes a set number of articles W arranged in a planar manner. The support P may be, for example, a pallet such as a flat pallet. In the present embodiment, for example, the set number is 12. In this case, 12 articles W arranged in a planar manner in a grid of 3×4 form a single article layer WG. In FIG. 1, the first warehouse 1 stores a support P on which four article layers WG are stacked. More specifically, 48 articles W are loaded on the support P. The article layers WG on other supports P in FIG. 1 and the article layers WG on each support P in FIGS. 2 to 9 are not labeled with WG to avoid complexity.

Each article W has an outer shape of a rectangular prism (including a cube). Each article W is loaded on a support P with one outer surface facing upward. Each article W is loaded on a support P directly or with one or more other articles W below the article W. The first warehouse 1 stores multiple supports P, each loaded with one article W or multiple articles W of the same type. The articles W of the same type have the same outer diameter and the same dimensions.

In the present embodiment, the articles W are containers (e.g., cardboard boxes) for containing loads (e.g., products). The type of article W is determined as appropriate for the type of load to be contained in the article W. Thus, each support P stored in the first warehouse 1 receives one article W containing a load or multiple articles W containing the same type of load.

The first warehouse 1 can store multiple supports P loaded with one or more articles W. The first warehouse 1 is an automated warehouse that automatically transfers supports P (e.g., an automated warehouse using stacker cranes). The first warehouse 1 may be divided into an area in which first supports P1 (described later) are stored and an area in which supports P other than the first supports P1 are stored. This structure may be used when, for example, the first supports P1 are transferred from the first warehouse 1 with priority.

The second warehouse 2 can store multiple articles W (articles W unloaded from a support P). The second warehouse 2 is an automated warehouse that automatically transfers articles W (e.g., an automated warehouse using shuttle carts). The articles W stored in the second warehouse 2 are transferred from the second warehouse 2 and then loaded onto a shipping support P4 (described later). The articles W stored in the second warehouse 2 are transferred from the second warehouse 2 in, for example, the order in which the articles W are loaded onto the shipping support P4.

As shown in FIG. 1, the article shipment system 100 according to the present embodiment includes a first transporter 11, a second transporter 12, a third transporter 13, a fourth transporter 14, a fifth transporter 15, a sixth transporter 16, and a seventh transporter 17. The transporters (11 to 17) may be, for example, conveyors such as belt conveyors and roller conveyors, or transport vehicles such as automated guided vehicles.

The first transporter 11 transports, to the first work area A1, supports P transferred from the first warehouse 1. The first transporter 11 transports, to the first work area A1 from the first warehouse 1, supports P loaded with at least articles W to be shipped.

The second transporter 12 transports supports P to be transferred into the first warehouse 1 from the first work area A1 to the first warehouse 1. The second transporter 12 transports, from the first work area A1 to the first warehouse 1, supports P loaded with remaining articles W not shipped to the shipping area A3 among the articles W transported into the first work area A1 (specifically, remaining articles W not transported to the shipping area A3 or the second warehouse 2).

The third transporter 13 transports articles W to be transferred into the second warehouse 2 from the first work area A1 to the second warehouse 2. The third transporter 13 transports shipping target articles W (specifically, articles W loaded on a shipping support P4 for shipping, described later) from the first work area A1 to the second warehouse 2.

The fourth transporter 14 transports, to the second work area A2, articles W transferred from the second warehouse 2. The fourth transporter 14 transports shipping target articles W (specifically, articles W loaded on the shipping support P4 for shipping, described later) from the second warehouse 2 to the second work area A2.

The fifth transporter 15 transports, to the shipping area A3, supports P transferred from the first warehouse 1. The fifth transporter 15 transports supports P loaded with shipping target articles W alone from the first warehouse 1 to the shipping area A3. The fifth transporter 15 directly transports supports P to the shipping area A3 (specifically, without the supports P passing through the first work area A1, the second warehouse 2, and the second work area A2).

The sixth transporter 16 transports supports P from the first work area A1 to the shipping area A3. The sixth transporter 16 transports supports P loaded with shipping target articles W alone from the first work area A1 to the shipping area A3. The sixth transporter 16 directly transports supports P to the shipping area A3 (specifically, without the supports P passing through the first warehouse 1, the second warehouse 2, and the second work area A2).

The seventh transporter 17 transports supports P from the second work area A2 to the shipping area A3. The seventh transporter 17 transports supports P loaded with shipping target articles W alone from the second work area A2 to the shipping area A3. The seventh transporter 17 directly transports supports P to the shipping area A3 (specifically, without the supports P passing through the first warehouse 1, the first work area A1, and the second warehouse 2).

The article shipment system 100 includes a control system 3 that controls the shipment process for articles W performed by the article shipment system 100. The control system 3 includes a computation processor such as a central processing unit (CPU) and peripheral circuits such as a memory. The functions of the control system 3 are implemented by hardware such as the computation processor and a program executed on the hardware cooperating with each other. The control system 3 may be implemented by multiple devices that can communicate with one another, rather than by a single device (e.g., a computer such as a personal computer or a workstation).

The control system 3 controls the first warehouse 1, the first work device 21, and the second work device 22. In the present embodiment, the control system 3 further controls the second warehouse 2, the first transporter 11, the second transporter 12, the third transporter 13, the fourth transporter 14, the fifth transporter 15, the sixth transporter 16, and the seventh transporter 17. When the shipping area A3 includes the stacking device described above, the control system 3 may control the stacking device.

The shipment process performed by the article shipment system 100 is a process for shipping a specified number of articles W loaded on a support P (one or more supports P). The specified number is specified by order information. In the shipment process in the present embodiment, the specified number of articles W are shipped to the shipping area A3. In the shipment process, the specified number of articles W are loaded on one support P or on multiple supports P to be shipped to the shipping area A3.

The article shipment system 100 in the present embodiment handles multiple types of articles W. The order information thus specifies the types of articles W (article types) and the number of articles W (the numbers of articles) for each type. For multiple article types specified in the order information, the article shipment system 100 ships the specified number of articles W for each type (the number of articles for each type) loaded on a support(s) P.

The order information is generated by the control system 3 or another device that can communicate with the control system 3 (e.g., a management device as a host device of the control system 3). The order information is generated based on, for example, an order for articles W from a shipping destination. The article types and the number of articles for each type in the order information are specified for each shipping destination.

As described above, each support P can receive multiple article layers WG stacked in the vertical direction V. Each article layer WG includes a set number of articles W arranged in a planar manner. The maximum number of articles W loadable on the support P, which is referred to as a maximum loading number, is an integer multiple of the set number. In the present embodiment, 12 articles W define a single article layer WG. A maximum of four article layers WG are stacked on the support P in the vertical direction V. In the present embodiment, the set number is thus 12, and the maximum loading number is 48.

In the present embodiment, four numbers, or specifically, 12, 24, 36, and 48, are the integer multiples of the set number less than or equal to the maximum loading number. When the number of articles W on a support P is an integer multiple of the set number (one of the above four numbers in the present embodiment), the uppermost layer of articles W on the support P is defined by an article layer WG. The uppermost layer of articles W on the support P can thus have a substantially flat upper surface. When the number of articles W on a support P is not an integer multiple of the set number, the multiple articles W loaded on the support P can have a state in which the uppermost layer of the articles W has a substantially flat upper surface. In particular, when the difference between the number of articles W on the support P and an integer multiple of the set number is small (e.g., when the articles W on the support P are fewer than an integer multiple of the set number by one), the multiple articles W loaded on the support P can have the state in which the uppermost layer of the articles W has a substantially flat upper surface. As described above, when the number of articles W on a support P is not an integer multiple of the set number, the uppermost layer of the articles W on the support P can also have a substantially flat upper surface.

With the uppermost layer of the articles W on a support P having a substantially flat upper surface, the support P can easily receive another support P. In other words, when the number of articles W on a support P is within a flat upper surface range, the support P can easily receive another support P. The flat upper surface range refers to a range (a range of the numbers of articles W) that allows the uppermost layer of articles W to have a substantially flat upper surface. The flat upper surface range is defined based on integer multiples of the set number. In the present embodiment, four numbers are the integer multiples of the set number less than or equal to the maximum loading number. This determines four ranges within the flat upper surface range.

The flat upper surface range is defined to have, for example, the upper limit being an integer multiple of the set number and the lower limit being the value obtained by subtracting a lower limit setting value from the integer multiple of the set number. The lower limit setting value is predetermined as, for example, 1 or 2 or is obtained by multiplying the set number by a predetermined multiplier (e.g., a value in the range of 0.05 to 0.2). In the present embodiment, for example, when the lower limit setting value is 1, eight numbers (integers) are within the flat upper surface range, or specifically, 11, 12, 23, 24, 35, 36, 47, and 48.

The uppermost layer of articles W on a support P may have a substantially flat upper surface only when the uppermost layer of the articles W on the support P is defined by an article layer WG. In this case, the flat upper surface range is defined to include only the integer multiples of the set number. When this structure is used in the present embodiment, the flat upper surface range includes four numbers (integers), or specifically, 12, 24, 36, and 48. For example, the lower limit setting value may be set greater than or equal to 0 and less than 1 (e.g., 0) to cause the flat upper surface range to include only integer multiples of the set number.

In the examples described below, one type of article W included in order information will be focused on. The first support P1 refers to a support P loaded with a first loading number of articles W when stored in the first warehouse 1. The second support P2 refers to a support P loaded with a second loading number of articles W when stored in the first warehouse 1. The second loading number is greater than or equal to the first loading number. A third support P3 refers to a support P loaded with a third loading number of articles W when stored in the first warehouse 1. The third loading number is greater than or equal to the second loading number. The first, second, and third loading numbers are all less than or equal to the maximum loading number.

The first warehouse 1 may store a support P loaded with less than the maximum loading number of articles W (hereafter referred to as a non-fully loaded support), in addition to a support P loaded with the maximum loading number of articles W (hereafter referred to as a fully loaded support). For example, when a fully loaded support stored in the first warehouse 1 is transferred from the first warehouse 1 and one or more articles W are unloaded before the support is re-transferred into the first warehouse 1, the support P stored in the first warehouse 1 serves as a non-fully loaded support.

When the first warehouse 1 stores zero non-fully loaded supports, any three fully loaded supports stored in the first warehouse 1 serves as the first support P1, the second support P2, and the third support P3.

When the first warehouse 1 stores one non-fully loaded support, the non-fully loaded support serves as the first support P1 and any two fully loaded supports stored in the first warehouse 1 serve as the second support P2 and the third support P3. In the example shown in FIG. 2(a) (referred to later), the first warehouse 1 stores one non-fully loaded support. In the example shown in FIG. 2(a), the first loading number is 42, the second loading number is 48, and the third loading number is 48. In this example, the first support P1 is one non-fully loaded support (the support P loaded with 42 articles W) stored in the first warehouse 1. The second support P2 and the third support P3 are two fully loaded supports (the supports P each loaded with 48 articles W) stored in the first warehouse 1.

When the first warehouse 1 stores two non-fully loaded supports, the two non-fully loaded supports serve as the first support P1 and the second support P2, and any one fully loaded support stored in the first warehouse 1 serves as the third support P3. In this case, the first support P1 and the second support P2 are determined to have the number of articles W loaded on the first support P1 being less than or equal to the number of articles W loaded on the second support P2.

When three or more non-fully loaded supports are stored in the first warehouse 1, any three non-fully loaded supports stored in the first warehouse 1 serve as the first support P1, the second support P2, and the third support P3. In this case, the first support P1, the second support P2, and the third support P3 are determined to have the number of articles W loaded on the second support P2 being less than or equal to the number of articles W loaded on the third support P3 and to have the number of articles W loaded on the first support P1 being less than or equal to the number of articles W loaded on the second support P2. For example, three non-fully loaded supports selected in order of fewer loaded articles W serve as the first support P1, the second support P2, and the third support P3.

Although the article shipment system 100 may operate to have two or more non-fully loaded supports stored in the first warehouse 1, the article shipment system 100 in the present embodiment operates to have zero or one (or specifically, a maximum of one) non-fully loaded support stored in the first warehouse 1. In the present embodiment, the second loading number and the third loading number are thus each the maximum loading number (48 in the present embodiment).

Specific examples (eight examples) of the shipment process performed by the article shipment system 100 will now be described with reference to FIGS. 2 to 9. Although the specific examples below focus on one type of article W included in order information, order information may include multiple types of articles. In this case, the shipment process described below is performed for each of the multiple types of articles. Although the transporters (11 to 17) and the second work area A2 in FIG. 1 are not shown in FIGS. 2 to 9, the transporters (11 to 17) and the second work area A2 may be referred to in the examples described below.

### First Example

FIG. 2 is a diagram of a shipment process in a first example. In this example, as shown in FIG. 2(a), the third support P3 is stored in the first warehouse 1 in addition to at least the first support P1 and the second support P2. In this example, the specified number is 52. Thus, the number obtained by subtracting the second loading number (=48) from the specified number is 4 (=52−48), which is referred to as a second remaining loading number.

In this example, the first loading number is 42. Thus, the specified number (=52) is greater than the second loading number (=48), and the second remaining loading number (=4) is less than or equal to the first loading number (=42). When the specified number of articles W is greater than the second loading number and the second remaining loading number is less than or equal to the first loading number, the article shipment system 100 unloads the second remaining loading number of articles W from the first support P1 with the first work device 21, loads the second remaining loading number of articles W onto the shipping support P4 with the second work device 22, and ships the second support P2 and the shipping support P4. The shipping support P4 is a support P different from the three supports P1, P2, and P3.

More specifically, as shown in FIG. 2(a), the article shipment system 100 transfers the first support P1 and the second support P2 from the first warehouse 1. The article shipment system 100 then transports the first support P1 to the first work area A1 with the first transporter 11 and the second support P2 to the shipping area A3 with the fifth transporter 15.

As shown in FIG. 2(b), the article shipment system 100 then unloads, with the first work device 21, the second remaining loading number (=4) of articles W from the first support P1 transported into the first work area A1, and transports, with the third transporter 13, the unloaded second remaining loading number of articles W to the second warehouse 2 to transfer the articles W into the second warehouse 2. The articles W not to be shipped to the shipping area A3 (38 articles W in this example) remain on the first support P1. The article shipment system 100 transports the first support P1 to the first warehouse 1 with the second transporter 12 to re-transfer the first support P1 into the first warehouse 1. The first support P1 re-transferred into the first warehouse 1 serves as the first support P1 in the next shipment process.

Although not shown, the article shipment system 100 transfers the second remaining loading number (=4) of articles W from the second warehouse 2 to transport the articles W into the second work area A2 with the fourth transporter 14. The article shipment system 100 then loads, with the second work device 22, the second remaining loading number of articles W transported into the second work area A2 onto the shipping support P4, and then transports the shipping support P4 to the shipping area A3 with the seventh transporter 17. The multiple articles W may be loaded on the shipping support P4 with the uppermost layer of the articles W having a substantially flat upper surface. The shipping support P4 may be loaded with different types of articles W. In this case, for example, multiple types of articles W included in one piece of order information are loaded on one shipping support P4, or multiple types of articles W with the same destination from the shipping area A3 (e.g., multiple types of articles W shipped to the same distribution center) are loaded on one shipping support P4.

The article shipment system 100 performs the above shipment process to transport the second support P2 loaded with the second loading number (=48) of articles W and the shipping support P4 loaded with the second remaining loading number (=4) of articles W to the shipping area A3. More specifically, the specified number (=52) of articles W loaded on one or more supports P (the second support P2 and the shipping support P4 in this example) are shipped to the shipping area A3. In this example and the examples described below, the number of articles W (the second remaining loading number in this example) on the shipping support P4 refers to the number of articles W of the type focused on the examples. The shipping support P4 may thus be loaded further with other types of articles W.

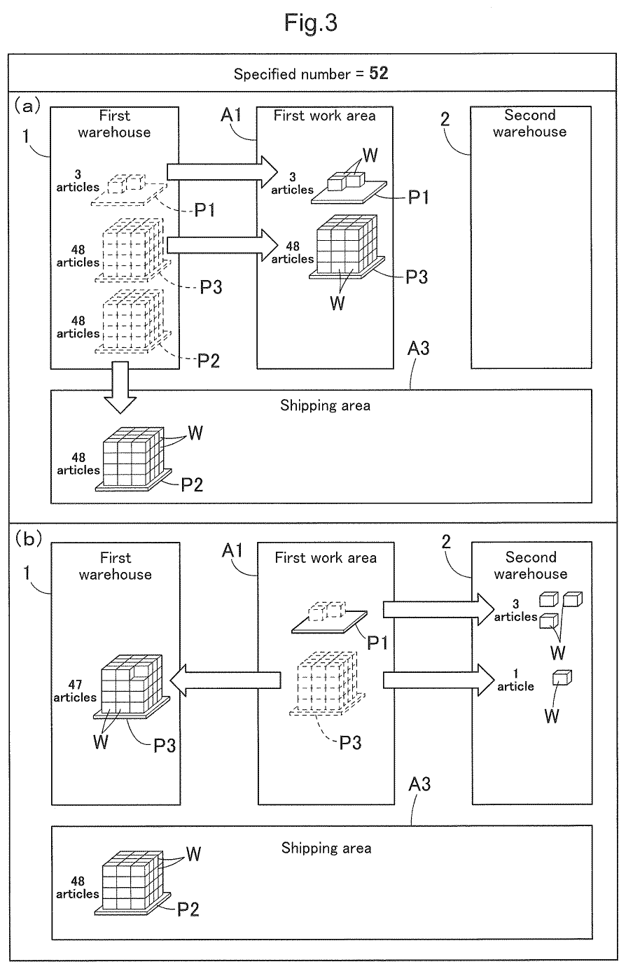

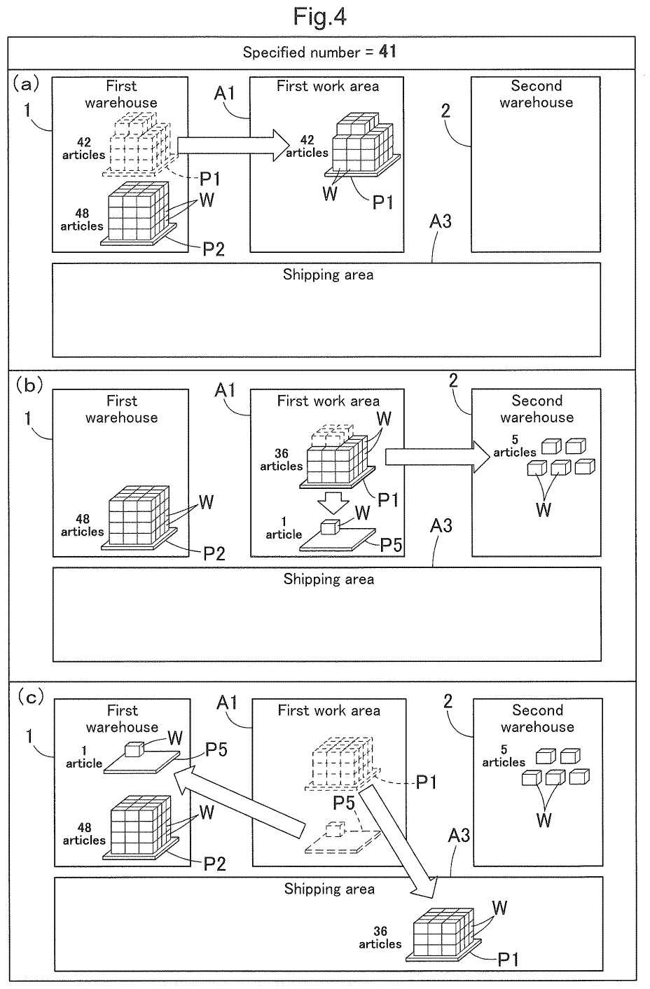

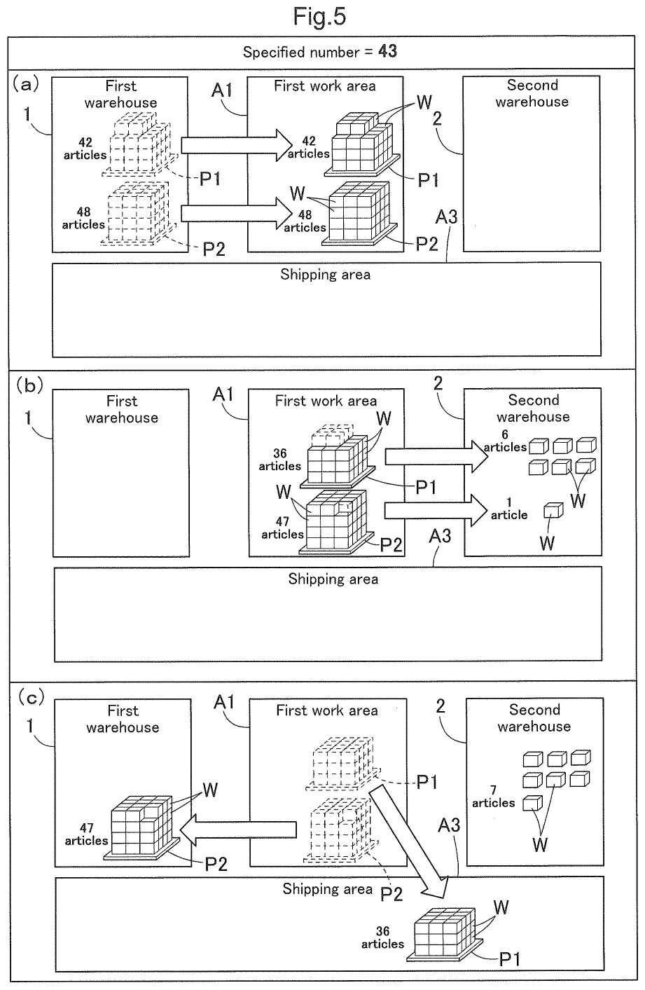

In the present example or the second example described below (FIG. 3), the second remaining loading number of articles W is small (specifically, the second remaining loading number is less than the set number) and all the second remaining loading number of articles W are loaded on the shipping support P4 when being shipped. However, when the second remaining loading number of articles W is large (specifically, the second remaining loading number is greater than or equal to the set number), the second remaining loading number of articles W may be loaded separately on the first support P1 (specifically, the first support P1 loaded with a flat-upper-surface number of articles W) and the shipping support P4 when being shipped, as in a third example (FIG. 4) or a fourth example (FIG. 5) described later.

### Second Example

FIG. 3 is a diagram of a shipment process in a second example. In this example, as shown in FIG. 3(a), the third support P3 is stored in the first warehouse 1, in addition to at least the first support P1 and the second support P2. In this example, the specified number is 52. Thus, the second remaining loading number is 4 (=52−48). These conditions are the same as in the first example (FIG. 2).

Unlike in the first example, the first loading number is 3 in this example. Thus, the specified number (=52) is greater than the second loading number (=48), and the second remaining loading number (=4) is greater than the first loading number (=3). The number obtained by subtracting the first loading number from the second remaining loading number is 1 (=4−3), which is referred to as a second shortage number. When the specified number is greater than the second loading number and the second remaining loading number is greater than the first loading number, the article shipment system 100 unloads the second shortage number of articles W from the third support P3 with the first work device 21, loads the first loading number of articles W unloaded from the first support P1 and the second shortage number of articles W unloaded from the third support P3 onto the shipping support P4 with the second work device 22, and ships the second support P2 and the shipping support P4.

More specifically, as shown in FIG. 3(a), the article shipment system 100 transfers the first support P1, the second support P2, and the third support P3 from the first warehouse 1. The article shipment system 100 then transports the first support P1 and the third support P3 to the first work area A1 with the first transporter 11 and transports the second support P2 to the shipping area A3 with the fifth transporter 15.

As shown in FIG. 3(b), the article shipment system 100 then unloads, with the first work device 21, all the first loading number (=3) of articles W from the first support P1 transported into the first work area A1, unloads, with the first work device 21, the second shortage number (=1) of articles W from the third support P3 transported into the first work area A1, and transports the unloaded second remaining loading number (=first loading number+second shortage number=4) of articles W to the second warehouse 2 with the third transporter 13 to transfer the articles W into the second warehouse 2. The articles W not to be shipped to the shipping area A3 (47 articles W in this example) remain on the third support P3. The article shipment system 100 transports the third support P3 to the first warehouse 1 with the second transporter 12 to re-transfer the third support P3 into the first warehouse 1. The third support P3 re-transferred into the first warehouse 1 serves as the first support P1 in the next shipment process.

After being transferred into the second warehouse 2, the second remaining loading number of articles W loaded on the shipping support P4 are transported to the shipping area A3, as in the first example. Thus, the second support P2 loaded with the second loading number (=48) of articles W and the shipping support P4 loaded with the second remaining loading number (=4) of articles W are transported to the shipping area A3.

When the specified number is greater than the second loading number and the second remaining loading number is greater than the first loading number, the article shipment system 100 may unload the second shortage number of articles W from the third support P3 with the first work device 21, load the second shortage number of articles W unloaded from the third support P3 onto the first support P1 with the first work device 21, and ship the second support P2 and the first support P1. When this structure is used in the situation shown in FIG. 3(a), the article shipment system 100 unloads, with the first work device 21, the second shortage number (=1) of articles W from the third support P3 transported into the first work area A1 and loads, with the first work device 21, the unloaded second shortage number of articles W onto the first support P1 transported into the first work area A1. The article shipment system 100 then transports the first support P1 loaded with the second remaining loading number (=4) of articles W to the shipping area A3 with the sixth transporter 16. Thus, the second support P2 loaded with the second loading number (=48) of articles W and the first support P1 loaded with the second remaining loading number (=4) of articles W are transported to the shipping area A3. More specifically, the specified number (=52) of articles W loaded on one or more supports P (the second support P2 and the first support P1 in this example) are shipped to the shipping area A3.

### Third Example

FIG. 4 is a diagram of a shipment process in a third example. In this example, as shown in FIG. 4(a), at least the first support P1 and the second support P2 are stored in the first warehouse 1. In this example, the specified number is 41, and the first loading number is 42. In this example, any number within the flat upper surface range that is less than or equal to the first loading number and less than or equal to the specified number is referred to as a flat-upper-surface number. As described above, the flat upper surface range is defined based on integer multiples of the set number. The flat upper surface range is the range that allows the uppermost layer of the articles W on a support P (the first support P1 in this example) to have a substantially flat upper surface.

In this example and the examples described below, the flat upper surface range is defined to include only the integer multiples of the set number. Thus, four numbers are within the flat upper surface range, or specifically, 12, 24, 36, and 48. In this example and the examples below, the number closest to the specified number among the numbers less than or equal to the first loading number and less than or equal to the specified number within the flat upper surface range is referred to as a flat-upper-surface number. In this example, the first loading number is 42, and the specified number is 41. Thus, the numbers less than or equal to the first loading number and less than or equal to the specified number within the flat upper surface range are 12, 24, and 36. Of these three numbers, 36, which is closest to the specified number (=41), is used as the flat-upper-surface number. Thus, the number obtained by subtracting the flat-upper-surface number from the specified number is 5 (=41−36), which is referred to as a first remaining loading number. The number obtained by subtracting the flat-upper-surface number from the first loading number is 6 (=42−36), which is referred to as a remaining number.

In this example, the specified number (=41) is greater than or equal to the set number (12) and less than the first loading number (=42). When the specified number is greater than or equal to the set number and less than the first loading number, the article shipment system 100 unloads the remaining number of articles W from the first support P1 with the first work device 21 while leaving the flat-upper-surface number of articles W on the first support P1, loads, with the second work device 22, the first remaining loading number of articles W among the remaining number of articles W onto the shipping support P4, and ships the first support P1 and the shipping support P4. In this example, the article shipment system 100 also loads the remaining articles W onto a storage support P5 with the first work device 21 and stores the storage support P5 into the first warehouse 1. The remaining articles W result from excluding the first remaining loading number of articles W from the remaining number of articles W. The storage support P5 is a support P for transferring articles W back into the first warehouse 1.

More specifically, as shown in FIG. 4(a), the article shipment system 100 transfers the first support P1 from the first warehouse 1. The article shipment system 100 then transports the first support P1 to the first work area A1 with the first transporter 11.

As shown in FIG. 4(b), the article shipment system 100 then unloads, with the first work device 21, the remaining number (=6) of articles W from the first support P1 transported into the first work area A1 and transports the first remaining loading number (=5) of articles W among the remaining number of articles W to the second warehouse 2 with the third transporter 13 to transfer the articles W into the second warehouse 2. The flat-upper-surface number (=36) of articles W remain on the first support P1. The article shipment system 100 also loads, with the first work device 21, the remaining articles W (one article Win this example) onto the storage support P5 (an empty support P loaded with no article W in this example). The remaining articles W result from excluding the first remaining loading number of articles W from the remaining number of articles W.

As shown in FIG. 4(c), the article shipment system 100 then transports the first support P1 loaded with the flat-upper-surface number (=36) of articles W to the shipping area A3 with the sixth transporter 16 and transports the storage support P5 to the first warehouse 1 with the second transporter 12 to transfer the storage support P5 into the first warehouse 1. The storage support P5 transferred into the first warehouse 1 serves as the first support P1 in the next shipment process.

After being transferred into the second warehouse 2, the first remaining loading number of articles W loaded on the shipping support P4 are transported to the shipping area A3, as in the first example. Thus, the first support P1 loaded with the flat-upper-surface number (=36) of articles W and the shipping support P4 loaded with the first remaining loading number (=5) of articles W are transported to the shipping area A3. Such a structure in which the first support P1 loaded with the flat-upper-surface number of articles W involves fewer operations for shipping than a structure in which all the specified number of articles W are unloaded from the first support P1 and loaded onto the shipping support P4.

In this example, the article shipment system 100 performs the above shipment process when the specified number is greater than or equal to the set number and less than the first loading number. The article shipment system 100 may also perform the above shipment process when the specified number is equal to the first loading number. More specifically, the article shipment system 100 may perform the above shipment process when the specified number is greater than or equal to the set number and less than or equal to the first loading number. When the specified number is equal to the first loading number, the remaining number is equal to the first remaining loading number. Thus, no article W is loaded onto the storage support P5.

In this example, the flat-upper-surface number is the number closest to the specified number among the numbers less than or equal to the first loading number and less than or equal to the specified number within the flat upper surface range. The flat-upper-surface number may not be limited to the number closest to the specified number. For example, the flat-upper-surface number may be the second closest number to the specified number among the numbers less than or equal to the first loading number and less than or equal to the specified number within the flat upper surface range. The flat-upper-surface number in this structure is 24 in the present example, instead of 36. In this case, the first support P1 loaded with the flat-upper-surface number (=24) of articles W and the shipping support P4 loaded with the first remaining loading number (=17) of articles W are transported to the shipping area A3. When the flat upper surface range is defined to include eight numbers of 11, 12, 23, 24, 35, 36, 47, and 48 and the flat-upper-surface number is the second closest number as described above, the flat-upper-surface number is 35, instead of 36, in the present example. In this case, the first support P1 loaded with the flat-upper-surface number (=35) of articles W and the shipping support P4 loaded with the first remaining loading number (=6) of articles W are transported to the shipping area A3.

### Fourth Example

FIG. 5 is a diagram of a shipment process in a fourth example. In this example, as shown in FIG. 5(a), at least the first support P1 and the second support P2 are stored in the first warehouse 1. In this example, the specified number is 43, and the first loading number is 42. In this example, as in the third example, the flat-upper-surface number is 36, and the remaining number is 6 (=42−36). Unlike in the third example, the first remaining loading number is 7 (=43−36) in this example. Thus, the number obtained by subtracting the remaining number from the first remaining loading number is 1 (=7−6), which is referred to as a first shortage number.

In this example, the specified number (=43) is greater than or equal to the set number (=12) and greater than the first loading number (=42). When the specified number is greater than the first loading number as in this example, the article shipment system 100 unloads the remaining number of articles W from the first support P1 with the first work device 21 while leaving the flat-upper-surface number of articles W on the first support P1, unloads the first shortage number of articles W from the second support P2 with the first work device 21, loads the remaining number of articles W and the first shortage number of articles W onto the shipping support P4 with the second work device 22, and ships the first support P1 and the shipping support P4.

More specifically, as shown in FIG. 5(a), the article shipment system 100 transfers the first support P1 and the second support P2 from the first warehouse 1. The article shipment system 100 then transports the first support P1 and the second support P2 to the first work area A1 with the first transporter 11.

As shown in FIG. 5(b), the article shipment system 100 then unloads, with the first work device 21, the remaining number (=6) of articles W from the first support P1 transported into the first work area A1, unloads the first shortage number (=1) of articles W from the second support P2 transported into the first work area A1, and transports the unloaded first remaining loading number (=the remaining number+the first shortage number=7) of articles W to the second warehouse 2 with the third transporter 13 to transfer the articles W into the second warehouse 2. The flat-upper-surface number (=36) of articles W remain on the first support P1. The articles W not to be shipped to the shipping area A3 (47 articles W in this example) remain on the second support P2.

As shown in FIG. 5(c), the article shipment system 100 then transports the first support P1 loaded with the flat-upper-surface number (=36) of articles W to the shipping area A3 with the sixth transporter 16 and transports the second support P2 to the first warehouse 1 with the second transporter 12 to transfer the second support P2 into the first warehouse 1. The second support P2 transferred into the first warehouse 1 serves as the first support P1 in the next shipment process.

After being transferred into the second warehouse 2, the first remaining loading number of articles W loaded on the shipping support P4 are transported to the shipping area A3, as in the first example. Thus, the first support P1 loaded with the flat-upper-surface number (=36) of articles W and the shipping support P4 loaded with the first remaining loading number (=7) of articles W are transported to the shipping area A3.

### Fifth Example

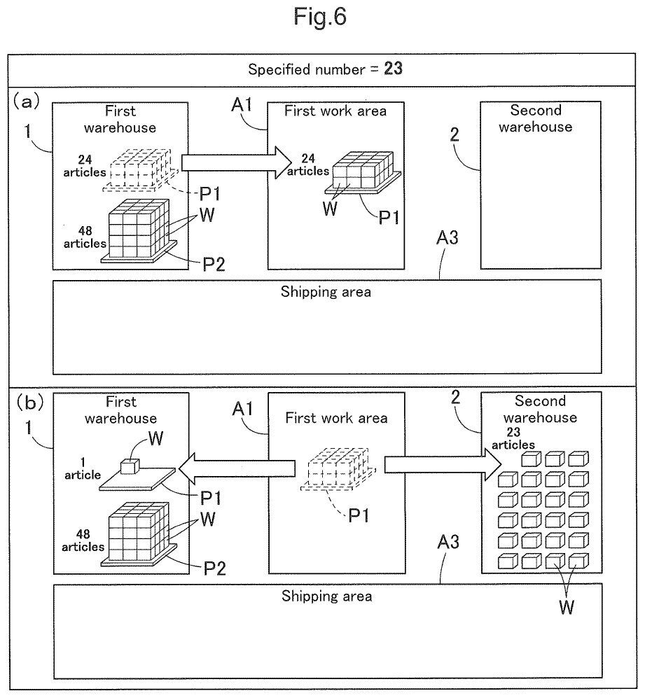

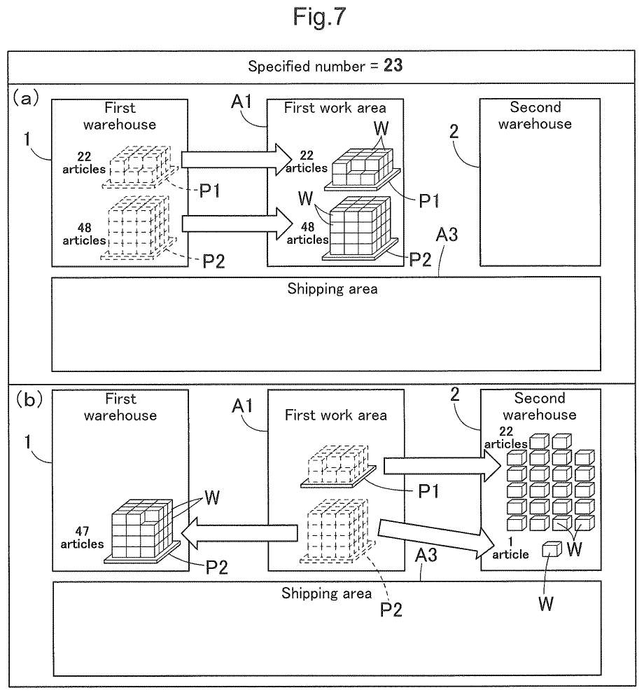

FIG. 6 is a diagram of a shipment process in a fifth example. In this example, as shown in FIG. 6(a), at least the first support P1 and the second support P2 are stored in the first warehouse 1. In this example, the specified number is 23, and the first loading number is 24. In this example, a value greater than or equal to the set number and less than the second loading number is set as a threshold. The threshold is, for example, an integer multiple of the set number (=12). In this example and the sixth example described later (FIG. 7), the threshold is 24, which is twice the set number.

In this example, the specified number (=23) is less than the threshold (=24) and less than the first loading number (=24). When the specified number is less than the threshold and less than the first loading number as in this example, the article shipment system 100 unloads the specified number of articles W from the first support P1 with the first work device 21 to load the unloaded articles W onto the shipping support P4 with the second work device 22, and ships the shipping support P4.

More specifically, as shown in FIG. 6(a), the article shipment system 100 transfers the first support P1 from the first warehouse 1. The article shipment system 100 then transports the first support P1 to the first work area A1 with the first transporter 11.

As shown in FIG. 6(b), the article shipment system 100 then unloads, with the first work device 21, the specified number (=23) of articles W from the first support P1 transported into the first work area A1 and transports the unloaded specified number of articles W to the second warehouse 2 with the third transporter 13 to transfer the articles W into the second warehouse 2. The article W not to be shipped to the shipping area A3 (one article W in this example) remains on the first support P1. The article shipment system 100 transports the first support P1 to the first warehouse 1 with the second transporter 12 to re-transfer the first support P1 into the first warehouse 1. The first support P1 re-transferred into the first warehouse 1 again serves as the first support P1 in the next shipment process.

After being transferred into the second warehouse 2, the specified number of articles W loaded on the shipping support P4 are transported to the shipping area A3, as in the first example. Thus, the shipping support P4 loaded with the specified number (=23) of articles W is transported to the shipping area A3.

In this example, the article shipment system 100 performs the above shipment process when the specified number is less than the threshold and less than the first loading number. The article shipment system 100 may also perform the above shipment process when the specified number is less than the threshold and equal to the first loading number. More specifically, the article shipment system 100 may perform the above shipment process when the specified number is less than the threshold and less than or equal to the first loading number.

### Sixth Example

FIG. 7 is a diagram of a shipment process in a sixth example. In this example, as shown in FIG. 7(a), at least the first support P1 and the second support P2 are stored in the first warehouse 1. In this example, the specified number is 23, the first loading number is 22, and the threshold is 24.

In this example, the specified number (=23) is less than the threshold (=24) and greater than the first loading number (=22). When the specified number is less than the threshold and greater than the first loading number as in this example, the article shipment system 100 unloads the specified number of articles W from the first support P1 and the second support P2 with the first work device 21 to load the unloaded articles W onto the shipping support P4 with the second work device 22, and ships the shipping support P4.

More specifically, as shown in FIG. 7(a), the article shipment system 100 transfers the first support P1 and the second support P2 from the first warehouse 1. The article shipment system 100 then transports the first support P1 and the second support P2 to the first work area A1 with the first transporter 11.

As shown in FIG. 7(b), the article shipment system 100 then unloads, with the first work device 21, the first loading number (=22) of articles W from the first support P1 transported into the first work area A1, unloads, with the first work device 21, the number (=1) of articles W obtained by subtracting the first loading number from the specified number from the second support P2 transported into the first work area A1, and transports the specified number (=23) of articles W, as a total number of unloaded articles W, to the second warehouse 2 with the third transporter 13 to transfer the articles W into the second warehouse 2. The articles W not to be shipped to the shipping area A3 (47 articles W in this example) remain on the second support P2. The article shipment system 100 transports the second support P2 to the first warehouse 1 with the second transporter 12 to re-transfer the second support P2 into the first warehouse 1. The second support P2 re-transferred into the first warehouse 1 serves as the first support P1 in the next shipment process.

After being transferred into the second warehouse 2, the specified number of articles W loaded on the shipping support P4 are transported to the shipping area A3, as in the first example. Thus, the shipping support P4 loaded with the specified number (=23) of articles W is transported to the shipping area A3.

### Seventh Example

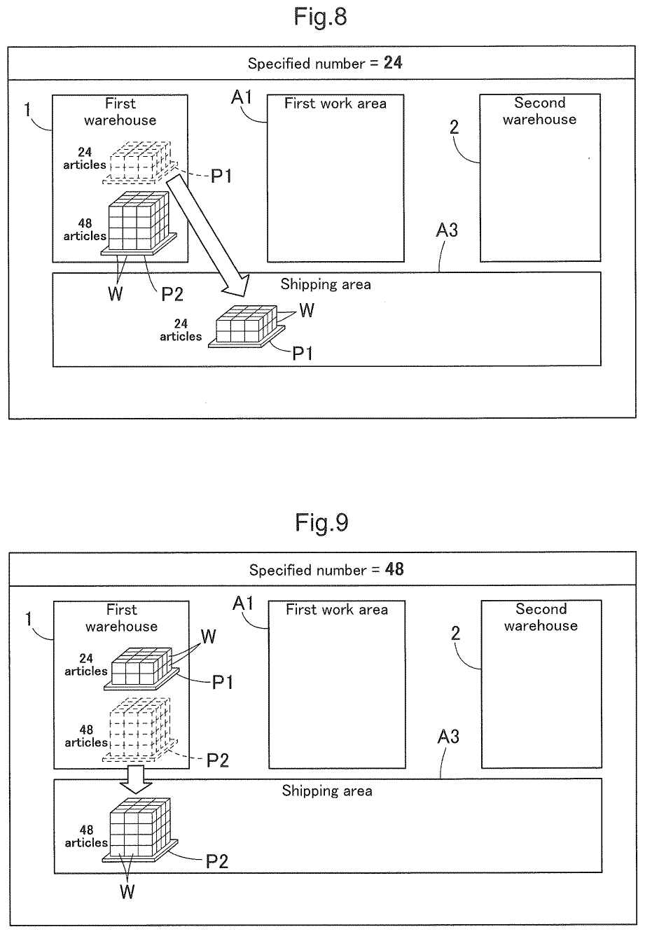

FIG. 8 is a diagram of a shipment process in a seventh example. In this example, as shown in FIG. 8, at least the first support P1 and the second support P2 are stored in the first warehouse 1. In this example, the specified number is 24, the first loading number is 24, and the flat upper surface range includes four numbers, or specifically, 12, 24, 36, and 48. In this example, both the first loading number and the specified number are 24. The flat-upper-surface number is thus 24.

In this example, the specified number (=24) is equal to the first loading number (=24), and the first loading number (=24) is the flat-upper-surface number (=24). When the specified number is equal to the first loading number and the first loading number is the flat-upper-surface number as in this example, the article shipment system 100 ships the first support P1. More specifically, as shown in FIG. 8, the article shipment system 100 transfers the first support P1 from the first warehouse 1. The article shipment system 100 then transports the first support P1 to the shipping area A3 with the fifth transporter 15. Thus, the first support P1 loaded with the specified number (=24) of articles W is transported to the shipping area A3.

### Eighth Example

FIG. 9 is a diagram of a shipment process in an eighth example. In this example, as shown in FIG. 9, at least the first support P1 and the second support P2 are stored in the first warehouse 1. In this example, the specified number is 48.

In this example, the specified number (=48) is equal to the second loading number (48). When the specified number is equal to the second loading number as in this example, the article shipment system 100 ships the second support P2. More specifically, as shown in FIG. 9, the article shipment system 100 transfers the second support P2 from the first warehouse 1. The article shipment system 100 then transports the second support P2 to the shipping area A3 with the fifth transporter 15. Thus, the second support P2 loaded with the specified number (=48) of articles W is transported to the shipping area A3.

### OTHER EMBODIMENTS

(1) In the above embodiments, the articles W to be loaded onto the shipping support P4 are stored in the second warehouse 2 before transported to the second work area A2. However, the disclosure is not limited to this structure. The articles W to be loaded onto the shipping support P4 may be transported to the second work area A2 without passing through the second warehouse 2 (e.g., transported directly to the second work area A2). In this case, the article shipment system 100 may or may not include the second warehouse 2.

(2) In the above embodiments, the articles W are loaded onto the shipping support P4 in the second work area A2. However, the disclosure is not limited to this structure. The articles W may be loaded onto the shipping support P4 in the first work area A1. In this case, the article shipment system 100 may or may not include the second work area A2. When the articles W are loaded onto the shipping support P4 in the first work area A1, the articles W may be loaded onto the shipping support P4 with the first work device 21 instead of with the second work device 22. In this case, the article shipment system 100 may or may not include the second work device 22.

(3) The structure described in each of the above embodiments may be combined with the structures described in other embodiments (including combinations of the other embodiments described as other embodiments) unless any contradiction arises. The embodiments described herein are mere examples in all respects. The embodiments may be modified variously without departing from the spirit and scope of the disclosure.

### Overview of Present Embodiment

An overview of the article shipment system according to the embodiments described above is provided below.

An article shipment system is a system for shipping a specified number of articles loaded on a support. The specified number is specified by order information. The support is loadable with a plurality of article layers vertically stacked on one another. Each of the plurality of article layers includes a set number of articles arranged in a planar manner. The article shipment system includes a warehouse that stores the support loaded with one or more articles, an unloading device that unloads an article among the one or more articles from the support, and a loading device that loads an article onto the support. The warehouse stores a first support loaded with a first loading number of articles and a second support loaded with a second loading number of articles. The second loading number is greater than or equal to the first loading number. The article shipment system, in response to the specified number being greater than or equal to the set number and less than the first loading number, unloads a remaining number of articles from the first support with the unloading device while leaving a flat-upper-surface number of articles on the first support, loads, with the loading device, a first remaining loading number of articles among the remaining number of articles onto a shipping support other than the first support and the second support, and ships the first support and the shipping support. The flat-upper-surface number is defined based on an integer multiple of the set number within a range to allow an uppermost article layer on the first support to have a substantially flat upper surface and is less than or equal to the first loading number and less than or equal to the specified number. The first remaining loading number is obtained by subtracting the flat-upper-surface number from the specified number. The remaining number is obtained by subtracting the flat-upper-surface number from the first loading number. The article shipment system, in response to the specified number being greater than the first loading number, unloads the remaining number of articles from the first support with the unloading device while leaving the flat-upper-surface number of articles on the first support, unloads a first shortage number of articles from the second support with the unloading device, loads the remaining number of articles and the first shortage number of articles onto the shipping support with the loading device, and ships the first support and the shipping support. The first shortage number is obtained by subtracting the remaining number from the first remaining loading number.

When the warehouse for storing supports loaded with article stores the first support and the second support, the structure can prepare the first support loaded with the flat-upper-surface number of articles and ship the specified number of articles with the first support and the shipping support, independently of whether the specified number specified by order information is less than or greater than the first loading number that is the number of articles loaded on the first support. The flat-upper-surface number is a number within the range that allows the uppermost article layer on the support to have a substantially flat upper surface. The prepared first support can thus be loaded with multiple articles to facilitate stacking of another support. When transporting the shipped support including the first support, another support including the shipping support can be easily stacked on the multiple articles loaded on the first support. This facilitates efficient transportation of the shipped articles.

As described above, for articles being loaded on a support to be stored in a warehouse, the structure can appropriately prepare a support (specifically, the first support) loaded with multiple articles to facilitate stacking of another support.

In the article shipment system, the warehouse may store the first support, the second support, and a third support loaded with a third loading number of articles. The third loading number may be greater than or equal to the second loading number. In response to the specified number being greater than the second loading number and a second remaining loading number obtained by subtracting the second loading number from the specified number being less than or equal to the first loading number, the article shipment system may unload the second remaining loading number of articles from the first support with the unloading device, load the second remaining loading number of articles onto the shipping support with the loading device, and ship the second support and the shipping support. In response to the specified number being greater than the second loading number and the second remaining loading number being greater than the first loading number, the article shipment system may unload a second shortage number of articles from the third support with the unloading device, load onto the shipping support with the loading device the first loading number of articles unloaded from the first support and the second shortage number of articles unloaded from the third support or load onto the first support with the loading device the second shortage number of articles unloaded from the third support, and ship the second support and the shipping support or ship the second support and the first support. The second shortage number may be obtained by subtracting the first loading number from the second remaining loading number.

This structure can ship the specified number of articles with the second support and the shipping support or with the second support and the first support when the specified number specified by order information is greater than the second loading number that is the number of articles loaded on the second support. The second remaining loading number of articles, which is the number obtained by subtracting the second loading number of articles from the specified number, is selectively assigned to the articles loaded on the first support among the first support and the third support. This easily reduces the number of supports stored in the warehouse on which few articles are loaded. This structure easily reduces the number of supports transferred from the warehouse for shipping a specified number of articles.

The second loading number may be a maximum number of articles loadable onto the support and may be an integer multiple of the set number.

This structure allows the first support alone to be loaded with the number of articles that are fractions of the maximum value. This structure easily reduces the number of supports transferred from the warehouse for shipping a specified number of articles. The structure also allows the second support to be loaded with multiple articles to facilitate stacking of another support. Thus, when the second support is shipped without undergoing any process, another support can be easily stacked on the multiple articles loaded on the second support, allowing efficient transportation of the shipped articles.

The article shipment system may ship the first support in response to the specified number being equal to the first loading number and the first loading number being the flat-upper-surface number. The article shipment system may ship the second support in response to the specified number being equal to the second loading number.

This structure can quickly ship the specified number of articles when the specified number is equal to the first loading number that is the flat-upper-surface number or when the specified number is equal to the second loading number.

The article shipment system may load, with the loading device, remaining articles resulting from excluding the first remaining loading number of articles from the remaining number of articles onto a storage support, and store the storage support into the warehouse. The storage support may be a support for transferring articles back into the warehouse.

In this structure, the articles remaining after the specified number of articles are shipped can be loaded on the storage support to be stored in the warehouse. This allows the storage support stored in the warehouse to be used as the first support for the next shipment of a specified number of articles.

In response to the specified number being less than a threshold and less than the first loading number, the article shipment system may unload the specified number of articles from the first support with the unloading device to load the unloaded articles onto the shipping support with the loading device and ship the shipping support. The threshold may be a value greater than or equal to the set number and less than the second loading number. In response to the specified number being less than the threshold and greater than the first loading number, the article shipment system may unload the specified number of articles from the first support and the second support with the unloading device to load the unloaded articles onto the shipping support with the loading device, and ship the shipping support.

Multiple articles loaded on the first support as an article group to facilitate stacking of another support may have a low height. In this case, when transporting the articles shipped in a stack of multiple supports including the first support sandwiching the articles, the ratio of the total height (total thickness) of the multiple supports to the height of the stack is high. This can reduce the transport efficiency of the shipped articles. In response to this, the structure can ship the specified number of articles with the shipping support, instead of the first support, when the specified number specified by order information is less than a threshold. Thus, the threshold is set appropriately to prevent a first support loaded with an article group having too low a height from being shipped. This reduces the likelihood of the shipped articles being transported with lower efficiency as described above.

This structure can ship the specified number of articles not with the first support but with the shipping support when the specified number specified by order information is less than the threshold. Thus, the threshold is set appropriately to reduce the likelihood of a small specified number of articles shipped separately on multiple supports (e.g., the first support and the shipping support).

The article shipment system according to one or more embodiments of the disclosure produces at least one of the effects described above.

What is claimed is:

1. An article shipment system for shipping a specified number of articles loaded on a support, the specified number being specified by order information, the support being loadable with a plurality of article layers vertically stacked on one another, each of the plurality of article layers comprising a set number of articles arranged in a planar manner, the article shipment system comprising:
a warehouse configured to store the support loaded with one or more articles;
an unloading device configured to unload an article among the one or more articles from the support; and
a loading device configured to load an article onto the support, and:
wherein:
the warehouse stores a first support loaded with a first loading number of articles and a second support loaded with a second loading number of articles, the second loading number being greater than or equal to the first loading number,
the article shipment system is configured to, in response to the specified number being greater than or equal to the set number and less than the first loading number, unload a remaining number of articles from the first support with the unloading device while leaving a flat-upper-surface number of articles on the first support, load, with the loading device, a first remaining loading number of articles among the remaining number of articles onto a shipping support other than the first support and the second support, and ship the first support and the shipping support, the flat-upper-surface number being defined based on an integer multiple of the set number within a range to allow an uppermost article layer on the first support to have a substantially flat upper surface and being less than or equal to the first loading number and less than or equal to the specified number, the first remaining loading number being obtained by subtracting the flat-upper-surface number from the specified number, the remaining number being obtained by subtracting the flat-upper-surface number from the first loading number, and
the article shipment system is configured to, in response to the specified number being greater than the first loading number, unload the remaining number of articles from the first support with the unloading device while leaving the flat-upper-surface number of articles on the first support, unload a first shortage number of articles from the second support with the unloading device, load the remaining number of articles and the first shortage number of articles onto the shipping support with the loading device, and ship the first support and the shipping support, the first shortage number being obtained by subtracting the remaining number from the first remaining loading number.

2. The article shipment system according to claim 1, wherein:
the warehouse stores the first support, the second support, and a third support loaded with a third loading number of articles, and the third loading number is greater than or equal to the second loading number,
in response to the specified number being greater than the second loading number and a second remaining loading number obtained by subtracting the second loading number from the specified number being less than or equal to the first loading number, the article shipment system unloads the second remaining loading number of articles from the first support with the unloading device, loads the second remaining loading number of articles onto the shipping support with the loading device, and ships the second support and the shipping support, and
in response to the specified number being greater than the second loading number and the second remaining loading number being greater than the first loading number, the article shipment system unloads a second shortage number of articles from the third support with the unloading device, loads onto the shipping support with the loading device the first loading number of articles unloaded from the first support and the second shortage number of articles unloaded from the third support or loads onto the first support with the loading device the second shortage number of articles unloaded from the third support, and ships the second support and the shipping support or ships the second support and the first support, and the second shortage number is obtained by subtracting the first loading number from the second remaining loading number.

3. The article shipment system according to claim 1, wherein:
the second loading number is a maximum number of articles loadable onto the support and is an integer multiple of the set number.

4. The article shipment system according to claim 1, wherein:
the article shipment system ships the first support in response to the specified number being equal to the first loading number and the first loading number being the flat-upper-surface number, and
the article shipment system ships the second support in response to the specified number being equal to the second loading number.

5. The article shipment system according to claim 1, wherein:
the article shipment system loads, with the loading device, remaining articles resulting from excluding the first remaining loading number of articles from the remaining number of articles onto a storage support, and stores the storage support into the warehouse, and the storage support is a support for transferring articles back into the warehouse.

6. The article shipment system according to claim 1, wherein:
in response to the specified number being less than a threshold and less than the first loading number, the article shipment system unloads the specified number of articles from the first support with the unloading device to load the unloaded articles onto the shipping support with the loading device and ships the shipping support, and the threshold is a value greater than or equal to the set number and less than the second loading number, and
in response to the specified number being less than the threshold and greater than the first loading number, the article shipment system unloads the specified number of articles from the first support and the second support with the unloading device to load the unloaded articles onto the shipping support with the loading device, and ships the shipping support.
